(19) United States
(12) Patent Application Publication
(10) Pub. No.: US 2019/0116724 A1
(43) Pub. Date: Apr. 25, 2019

(54) PARTICULAR MATERIAL SPREADER

(71) Applicant: PREMIER TECH TECHNOLOGIES LTÉE, Rivière-du-Loup (CA)

(72) Inventors: Paul LEFEBVRE, Durham (CA); Robert CAYER, Mississauga (CA); Rita BIELLO, Pierrefonds (CA); Jérôme Frédéric BOUCHARD, St-André-de-Kamouraska (CA); Michel E. GUAY, Montréal (CA); Karine LANELIER-SAVARD, Notre-Dame-Du-Portage (CA); Benoit ORBAN, Saint-Lambert (CA); Francois GAUCHER, Beloeil (CA); Manuel LÉVEILLÉ, Montréal (CA); Mario GAGNON, Montréal (CA); Pierre TALBOT, Notre-Dame-du Portage (CA)

(73) Assignee: PREMIER TECH TECHNOLOGIES LTÉE, Rivière-du-Loup, QC (CA)

(21) Appl. No.: 16/093,309

(22) PCT Filed: Apr. 12, 2017
(86) PCT No.: PCT/CA2017/050455

§ 371 Date: Oct. 12, 2018

Related U.S. Application Data
(60) Provisional application No. 62/321,473, filed on Apr. 12, 2016.

(51) Int. Cl. A01C 17/00; B05C 19/04; A01C 15/02

(52) U.S. Cl. CPC A01C 17/001; A01C 17/008; A01C 15/02; B05C 19/04

(57) ABSTRACT

A particulate material spreader for radially projecting granular material. The particulate material spreader comprises a hopper, a set of open wheels and a spreading assembly at least partially extending between the hopper and the set of open wheels. The spreading assembly is configured to radially project the particulate material through at least one wheel of the set of open wheels. The spreading assembly comprises a wheel axle extending between the open wheels and rotating along with the open wheels when the particulate material spreader is moved over a surface; a distribution shaft operatively connected to the wheel axle to rotate along therewith; and a distribution plate. The distribution plate is mounted to the distribution shaft, receives the particulate material from the hopper and radially projects the particulate material substantially through at least one wheel of the set of open wheels.

### CROSS REFERENCE TO RELATED APPLICATION

This application claims the benefit under 35 U.S.C. § 119(e) of U.S. provisional patent application No. 62/321,473 which was filed on Apr. 12, 2016. The entirety of the aforementioned application is herein incorporated by reference.

### TECHNICAL FIELD OF THE INVENTION

The present invention relates to the field of spreaders. More particularly, it relates to a particulate material spreader for spreading particulate material over a surface.

### BACKGROUND

Particulate material spreaders are apparatuses commonly used to spread particulate material onto a surface over which the spreader is moved. Such spreaders commonly include a hopper having a bottom wall with openings defined therein and a spreading assembly positioned below the hopper to receive the particulate material from the hopper and distribute the particulate material in the vicinity of the spreader, during displacement thereof. For example and without being limitative, the spreading assembly can include a distribution plate operatively connected to a set of wheels, where rotation of the distribution plate is directly linked to the rotation of the wheels (i.e. the distribution plate rotates when the wheels turn and remains still when movement of the wheels is ceased).

Known spreaders however tend to suffer from several drawbacks. For example and without being limitative, spreader carts which are commonly used as particulate material spreaders are typically cumbersome apparatuses that are used only on limited occasions by their owners, but tend to take up a lot of storage space when stored between usages, which is undesirable. Moreover, particulate material spreaders tend to be corrosion prone (i.e. tend to suffer from corrosion resulting from the spreading of oxidizing products (e.g. fertilizers, salts, etc.) and/or from the use or storage conditions of the spreader). For example and without being limitative, corrosion issues tend to be especially common for cables used as part of a flow control assembly operative to control the flow of particulate material through the openings in the bottom surface of the hopper and/or for the metallic tubular structure of the spreader. Furthermore, particulate material spreaders are typically apparatuses, which cannot be easily cleaned.

Known particulate material spreaders also commonly use closed wheels made of hard material and having a rather small diameter. The small diameter of the wheel allows the distribution of the particulate material by the spreading assembly, over the wheels. Such small diameter wheels result in poor maneuverability of the spreader, especially in winter conditions where ice and snow negatively impact the rotation of the wheels as the spreader is moved over the ground.

Finally, known particulate material spreaders do not offer a structure that allows the spreading of particulate material to be restricted on one or both sides thereof.

In view of the above, there is a need for an improved particulate material spreader which, by virtue of its design and components, would be able to overcome or at least minimize some of the above-discussed prior art concerns.

### BRIEF SUMMARY OF THE INVENTION

In accordance with a first general aspect, there is provided a particulate material spreader for radially projecting granular material substantially along a distribution plane when moved over a surface. The particulate material spreader comprises a hopper, a set of open wheels and a spreading assembly at least partially extending between the hopper and the set of open wheels. The hopper defines a particulate material receiving cavity having a particulate material outlet. The set of open wheels is operatively connected to the hopper and supports the hopper above the ground. The spreading assembly is configured to radially project the particulate material through at least one wheel of the set of open wheels. The spreading assembly comprises a wheel axle extending between the open wheels and rotating along with the open wheels when the particulate material spreader is moved over the surface; a distribution shaft operatively connected to the wheel axle to rotate along therewith; and a distribution plate. The distribution plate is mounted to the distribution shaft and extends substantially along the distribution plane. The distribution plate receives the particulate material from the hopper and radially projects the particulate material substantially along the distribution plane extending through at least one wheel of the set of open wheels.

In an embodiment, the wheels have a hub and a rim and the distribution plane extends above the hub and below an upper section of the rim for projecting the particulate material through at least one wheel of the set of open wheels.

In an embodiment, the particulate material spreader further comprises an undercarriage comprising a spreader frame extending at least partially below the hopper and engageable therewith. The undercarriage further comprises the set of open wheels rotatably mounted to the spreader frame and the spreading assembly.

In an embodiment, the spreader frame comprises a hopper engaging wall engageable with the hopper and wheel engaging supports. Each one of the wheel engaging supports has a wheel engaging end with a respective one of the wheels mounted thereon and the wheel engaging end of each one of the wheel engaging supports is vertically spaced apart from the hopper engaging wall to define a distribution gap therebetween.

In an embodiment, the spreader frame comprises a distribution channel in particulate material communication with the outlet of the material receiving cavity of the hopper and the spreading assembly further comprises an auger mounted to the distribution shaft. The auger is positioned inside the distribution channel and controls the flow of particulate material through the distribution channel.

In an embodiment, the auger comprises multiple helical walls.

In an embodiment, the auger comprises at least three helical walls with overlapping end sections.

In an embodiment, each one of the helical walls of the auger is made of resilient material.

In an embodiment, at least one of the helical walls of the auger has a non-slip upper surface.

In an embodiment, the particulate material spreader is configurable between an operative configuration where the hopper is secured onto the spreader frame of the undercarriage and a disassembled configuration where the hopper is disengaged from the spreader frame of the undercarriage.

In an embodiment, the particulate material spreader further comprises a handle detachably mounted to one of the hopper and the spreader frame of the undercarriage. The handle is secured onto at least one of the hopper and the spreader frame when the particulate material spreader is configured in the operative configuration and is at least partially disengaged from the at least one of the hopper and the undercarriage when the particulate material spreader is configured in the disassembled configuration.

In an embodiment, the particulate material spreader is further configurable in a compacted configuration where the undercarriage is at least partially received in the particulate material receiving cavity of the hopper.

In an embodiment, the hopper has an outer surface including at least one of a male member and a female member. The hopper engaging wall of the spreader frame comprises at least one of the other one of the male member and the female member for engagement of the hopper to the hopper engaging wall in a male-female relationship.

In an embodiment, the hopper comprises at least one frame engaging projection projecting from the outer surface of the bottom wall thereof and the hopper engaging wall of the spreader frame comprises at least one projection receiving cavity sized and shaped to receive therein at least a portion of a corresponding one of the at least one frame engaging projection.

In an embodiment, the spreading assembly further comprises at least one lateral blocking wall for selectively preventing the distribution of particulate material towards a corresponding side of the particulate material spreader. The at least one lateral blocking wall has an inner surface and is vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

In an embodiment, the distribution plate is substantially circular and has a peripheral edge and the at least one lateral blocking wall has a longitudinal curved profile substantially matching the peripheral edge of the distribution plate. The at least one lateral blocking wall is positioned proximate to a corresponding section of the peripheral edge of the distribution plate when configured in the blocking configuration.

In an embodiment, the spreading assembly further comprises a rear blocking wall extending across the distribution plane along a rear section of the particulate material spreader. The rear blocking wall has a curved profile substantially matching the peripheral edge of the distribution plate and is positioned proximate to a corresponding section of the peripheral edge of the distribution plate to prevent the distribution of particulate material along the rear section of the particulate material spreader.

In an embodiment, the inner surface of the at least one lateral blocking wall comprises at least one elongated projection extending therefrom. The at least one elongated projection is substantially horizontal when the at least one lateral blocking wall is configured in the blocking configuration.

In an embodiment, the inner surface of the at least one lateral blocking wall has a substantially concave configuration along a height thereof.

In an embodiment, the outlet of the particulate material receiving cavity of the hopper comprises at least one aperture and the particulate material spreader comprises a flow controller pivotally mounted below the outlet of the particulate material receiving cavity of the hopper. The flow controller has a flow controller body with at least one aperture defined therein. The quantity, size and shape of the at least one aperture defined in the flow controller body substantially matches the quantity, size and shape of the at least one aperture of the outlet of the particulate material receiving cavity of the hopper and the flow controller is pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

In accordance with another general aspect, there is further provided a particulate material spreader. The particulate material spreader comprises a hopper, a set of wheels and a spreading assembly at least partially extending between the hopper and the set of wheels. The hopper defines a particulate material receiving cavity having a particulate material outlet. The set of wheels is operatively connected to the hopper and supports the hopper above the ground. The spreading assembly comprises a wheel axle extending between the wheels and rotating along with the wheels; a distribution shaft operatively connected to the wheel axle and rotating along therewith; a distribution plate mounted to the distribution shaft rotating along with the distribution shaft; and an auger mounted to the distribution shaft and rotating along with the distribution shaft. The distribution plate receives the particulate material from the hopper and radially projects the particulate material upon rotation thereof. The auger is positioned between the outlet of the particulate material receiving cavity of the hopper and the distribution plate and controls the flow of particulate material towards the distribution plate.

In an embodiment, the particulate material spreader further comprises an undercarriage comprising a spreader frame extending at least partially below the hopper and engageable therewith. The undercarriage further comprises the set of wheels rotatably mounted to the spreader frame and the spreading assembly. The spreader frame has a distribution channel in particulate material communication with the outlet of the particulate material receiving cavity of the hopper defined therein and the auger is positioned inside the distribution channel for controlling the flow of particulate material through the distribution channel.

In an embodiment, the spreader frame comprises a hopper engaging wall engageable with the hopper and wheel engaging supports. Each one of the wheel engaging supports has a wheel engaging end with a respective one of the wheels mounted thereon and the wheel engaging end of each one of the wheel engaging supports is vertically spaced apart from the hopper engaging wall to define a distribution gap therebetween.

One skilled in the art will understand that, in an embodiment, the particulate material spreader relative to this other general aspect can further include elements or characteristics described above with regards to embodiments relative to the first general aspect, with the necessary adaptations.

In accordance with another general aspect, there is further provided a particulate material spreader. The particulate material spreader comprises a hopper, a set of wheels and a spreading assembly extending at least partially between the hopper and the set of wheels. The hopper defines a particulate material receiving cavity having a particulate material outlet. The set of wheels is operatively connected to the hopper and supports the hopper above the ground. The spreading assembly comprises a wheel axle extending between the wheels and rotating along with the wheels; a distribution shaft operatively connected to the wheel axle and rotating along therewith; a distribution plate mounted to the distribution shaft and rotating along therewith; and at least one lateral blocking wall for selectively preventing the distribution of particulate material towards a corresponding side of the particulate material spreader. The distribution plate extends substantially along a distribution plane to receive the particulate material from the hopper and radially project the particulate material substantially along the distribution plane upon rotation thereof. The at least one lateral blocking wall has an inner surface and is vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

Once again, one skilled in the art will understand that, in an embodiment, the particulate material spreader relative to this other general aspect can further include elements or characteristics described above with regards to embodiments relative to the first general aspect, with the necessary adaptations.

In accordance with another general aspect, there is further provided a particulate material spreader. The particulate material spreader comprises a hopper, a set of wheels and a spreading assembly at least partially extending between the hopper and the set of wheels. The hopper defines a particulate material receiving cavity having a particulate material outlet. The set of wheels is operatively connected to the hopper and supports the hopper above the ground. The spreading assembly comprises a wheel axle extending between the wheels and rotating along with the wheels; a distribution shaft operatively connected to the wheel axle and rotating along therewith; a substantially circular distribution plate having a peripheral edge and extending substantially along a distribution plane; and a rear blocking wall extending across the distribution plane along a rear section of the particulate material spreader. The distribution plate is mounted to the distribution shaft to rotate along therewith and. The distribution plate receives the particulate material from the hopper and radially projects the particulate material substantially along the distribution plane upon rotation thereof. The rear blocking wall has a curved profile substantially matching the peripheral edge of the distribution plate and is positioned proximate to a corresponding section of the peripheral edge of the distribution plate to prevent the distribution of particulate material along the rear section of the particulate material spreader.

Once again, one skilled in the art will understand that, in an embodiment, the particulate material spreader relative to this other general aspect can further include elements or characteristics described above with regards to embodiments relative to the first general aspect, with the necessary adaptations.

In accordance with another general aspect, there is further provided a particulate material spreader. The particulate material spreader comprises a hopper defining a particulate material receiving cavity and an undercarriage. The undercarriage comprises a spreader frame engageable with the hopper, a set of wheels rotatably mounted to the spreader frame and a spreading assembly operatively connected to the set of wheels and rotating therewith for spreading the particulate material flowing from the hopper. The particulate material spreader is configurable between an operative configuration where the hopper is secured onto the spreader frame of the undercarriage and a disassembled configuration where the hopper is disengaged from the spreader frame.

Once again, one skilled in the art will understand that, in an embodiment, the particulate material spreader relative to this other general aspect can further include elements or characteristics described above with regards to embodiments relative to the first general aspect, with the necessary adaptations.

In accordance with another general aspect, there is further provided a particulate material spreader. The particulate material spreader comprises a hopper defining a particulate material receiving cavity and an undercarriage. The undercarriage comprises a spreader frame extending at least partially below the hopper and engageable therewith, a set of wheels rotatably mounted to the spreader frame and a spreading assembly operatively connected to the set of wheels and rotating therewith. The spreading assembly is operative to receive the particulate material from the hopper and spreading the received particulate material.

Once again, one skilled in the art will understand that, in an embodiment, the particulate material spreader relative to this other general aspect can further include elements or characteristics described above with regards to embodiments relative to the first general aspect, with the necessary adaptations.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is an isometric view of a particulate material spreader, in accordance with an embodiment and shown in an operative configuration.

FIG. 2 is a cross sectional view of the particulate material spreader of FIG. 1, taken along line 2-2 in FIG. 1.

FIG. 3 is an isometric partial view of the particulate material spreader of FIG. 1, shown in a disassembled configuration where a hopper is detached from an undercarriage of the particulate material spreader.

FIG. 4 is an exploded view of the particulate material spreader of FIG. 1.

FIG. 4a is an enlarged view of an auger of the particulate material spreader of FIG. 1.

FIGS. 5A, 5B and 5C are top isometric views of the particulate material spreader of FIG. 1, where FIG. 5A shows a pivoting flow controller in a fully open configuration, FIG. 5B shows the pivoting flow controller in a partially open configuration and FIG. 5C shows the pivoting flow controller in a closed configuration.

FIGS. 6A and 6B are enlarged isometric views of the undercarriage of the particulate material spreader of FIG. 1, where FIG. 6A shows a left side pivotable blocking wall and a right side pivotable blocking wall in a distribution configuration and FIG. 6B shows the left side pivotable blocking wall in the dispensing configuration and the right side pivotable blocking wall in a blocking configuration.

FIG. 7 is an isometric view of the particulate material spreader of FIG. 1, shown in a disassembled and compacted configuration.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the particulate material spreader and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the particulate material spreader, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

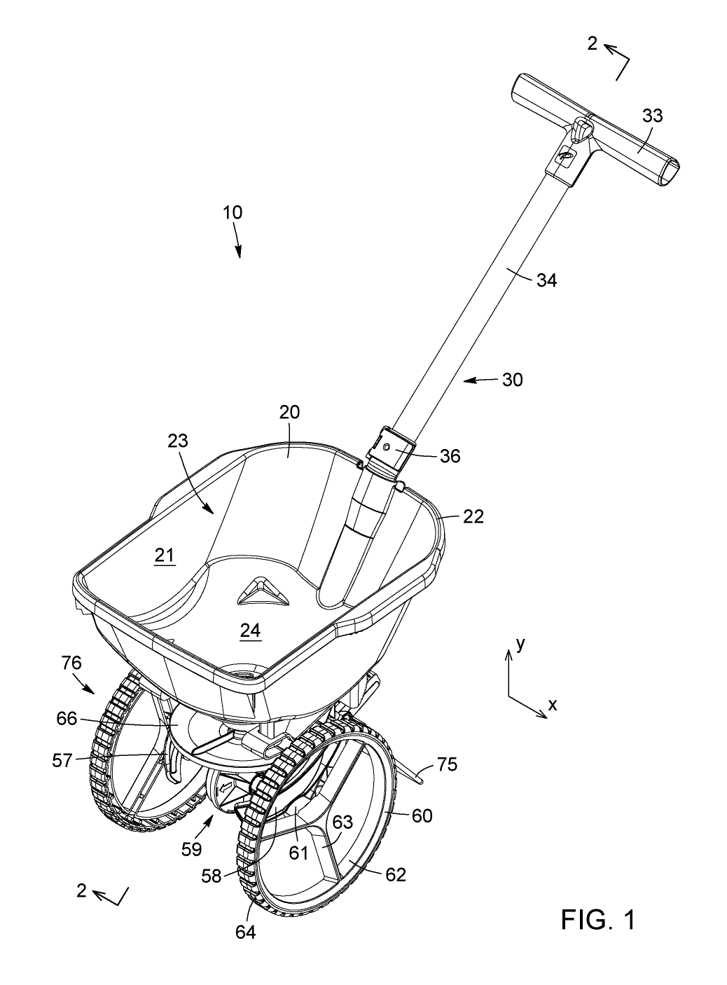

Referring generally to FIGS. 1 to 5C, there is shown a particulate material spreader 10, in accordance with one embodiment. The particulate material spreader is adapted to spread particulate material (not shown) onto a surface over which the particulate material spreader 10 is moved. In the course of the present description, the term “particulate material” (or particular material) is used to refer to any material in particular form and capable of being spread by centrifugal force (i.e. by rotation of a distribution plate (or impeller) onto which the particulate material is dropped), as will be described in more details below. For example and without being limitative, the particulate material includes granular material such as fertilizer pellets, salt, sand, or the like, and powder material such as lime, sand or the like. The particulate material spreader 10 includes a hopper 20 engageable with a spreader frame 46. The spreader frame 46 is operatively engaged to, and supported by, a set of wheels 60. The particulate material spreader 10 also includes a spreading assembly 59 operatively connected to the set of wheels 60 and operative to distribute the particulate material from the hopper 20, around the particulate material spreader 10, when the particulate material spreader 10 is moved over the surface by a user. In the course of the present description, the combination of the spreader frame 46, spreading assembly 59 and the set of wheels 60 will be referred to as the undercarriage 76. In the embodiment shown, the particulate material spreader 10 also includes a handle 30 engageable with the hopper 20 and/or the spreader frame 46 for maneuvering (i.e. pushing, pulling, or the like) the particulate material spreader 10.

In the embodiment shown in the appended Figures, the particulate material spreader 10 is of the push cart type. However, one skilled in the art will understand that, in alternative embodiments (not shown), the particulate material spreader 10 could be pulled by a pulling source, such as, for example and without being limitative, a motor vehicle, a human powered apparatus or the like, rather than being pushed by a user.

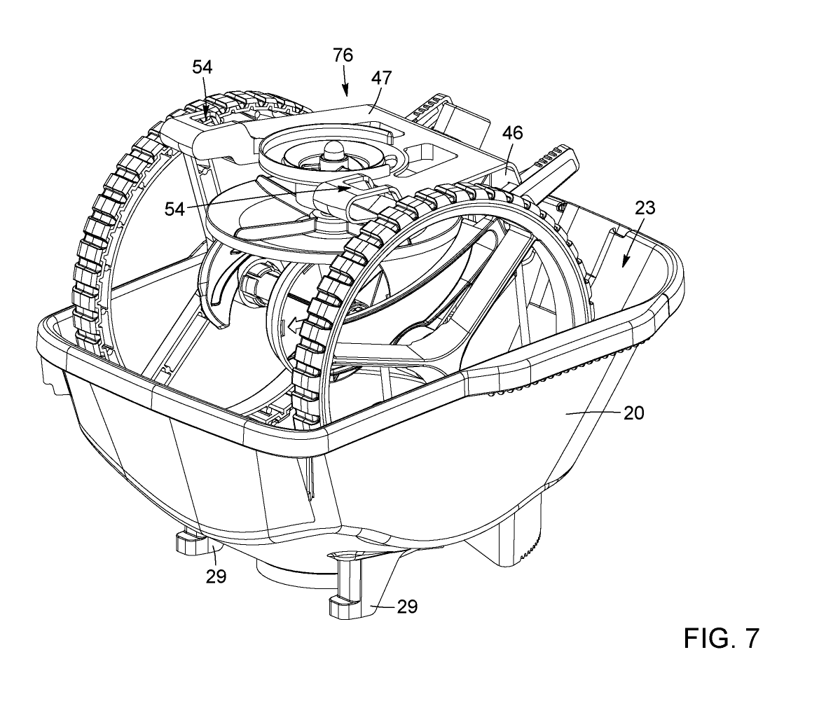

In an embodiment, the undercarriage 76 also includes a stand 75 connected to the spreader frame 46 and configured to maintain the particulate material spreader 10 in a substantially levelled configuration (see FIG. 1) when it is not handled by a user. In the embodiment shown, the stand 75 has a substantially “U” shaped configuration and is pivotally connected to opposite lateral ends of the spreader frame 46. For example and without being limitative, in an embodiment, the stand 75 can have projecting ends 75a insertable in receiving bores 46a of the spreader frame 46. In use, the stand 75 is rearwardly angled to offer better support to the particulate material spreader 10 when it is rested onto the stand 75. In an embodiment, the stand 75 can be pivoted towards the undercarriage 76, for example to insert the undercarriage 76 in the hopper 20 when the particulate material spreader 10 is configured in a compacted configuration, as will be described in more details below in reference to FIG. 7. One skilled in the art will understand that, in alternative embodiments (not shown), the stand 75 can have a shape, a size and/or a configuration different from the stand 75 of the embodiment shown, while still allowing the particulate material spreader 10 to be supported in a substantially levelled configuration. For example and without being limitative, in an embodiment (not shown), the stand 75 can be a fixed stand rather than a pivotable stand.

In an embodiment, the handle 30 is detachably engageable with at least one of the hopper 20 and the undercarriage 76. In the embodiment shown, the handle 30 includes a lower section 32 and an upper section 34 detachably connectable to one another. In the embodiment shown, the lower section 32 has an undercarriage engaging end 32a engageable with the spreader frame 46. When the handle 30 is engaged with the spreader frame 46 and the hopper 20 is mounted to the spreader frame 46, the lower section 32 of the handle 30 is juxtaposed to a peripheral wall 21 of the hopper 20, at a rear of the particulate material spreader 10. In the embodiment shown, the undercarriage engaging end 32a of the lower section 32 of the handle 30 is press fitted into a handle receiving cavity 55 of the spreader frame 46. In the embodiment shown, the lower section 32 of the handle 30 is also engaged with the hopper 20 through insertion of a section thereof into a receiving cavity 27 defined in a rear section of the peripheral wall 21 of the hopper 20. In an embodiment, the receiving cavity 27 is defined close to an open upper end 22 of the peripheral wall 21 of the hopper 20 and is characterized by a narrower opening to prevent disengagement of the handle 30 from the hopper 20, unless a disengagement force is applied (i.e. unless a sufficient force especially meant to perform disengagement therebetween is applied). One skilled in the art will understand that, in alternative embodiments (not shown), other mounting means or methods, such as a nuts and blot assembly, a push button insertable in a corresponding aperture, or the like, can be used for mounting the lower section 32 of the handle 30 to the spreader frame 46 or to the hopper 20.

The upper section 34 of the handle 30 has a connecting end 34a detachably engageable with a connecting end 32b of the lower section 32 of the handle 30. In the embodiment shown, the handle 30 includes a connector 36 which allows easy connection/disconnection between the upper section 34 and lower section 32 thereof. For example and without being limitative, in the embodiment shown, the connector 36 includes receiving bores at a lower end 36b and an upper end 36c thereof, each receiving bore being configured to receive the corresponding one of the connecting ends 32b, 34a of the lower section 32 and the upper section 34 of the handle 30. The lower section 32 of the handle is fixedly engaged to the connector 36, with a fastener 37 holding the connecting end 32a thereof in the receiving bore of the lower end 36b of the connector 36. In the embodiment shown, the connector 36 further includes a pivotable latch 36a having a projection (not shown) engageable in a locking aperture 34c defined in the upper section 34 of the handle 30, proximate to the connecting end 34a thereof. Hence, the pivotable latch 36a can be pivoted to engage/disengaged the projection in the locking aperture 34c to lock/unlock the upper section 34 and allow the connecting end 34a of the upper section 34 of the handle 30 to be inserted/removed from the receiving bore of the upper end 36c of the connector 36. One skilled in the art will understand that, in alternative embodiments (not shown), other connectors can be used for detachably connecting the lower section 32 and the upper section 34 of the handle 30. Moreover, in an embodiment, when engaged together, the upper section 34 is angled relative to the lower section 32 such that the user engaging end 34b is at a suitable height for grasp by a user. In an embodiment, the handle 30 also includes a “T” shaped member 33 engageable with the user end 34b of the upper section 34 to allow easy grasping and driving by the user. One skilled in the art will understand that, in alternative embodiments (not shown), the handle 30 can have a configuration different from the configuration of the embodiment shown. For example and without being limitative, the handle 30 can include a single section or more than two sections, can include two lateral sections rather than one central section, can be engageable solely with the hopper 20 or the spreader frame 46 rather than to the spreader frame 46 and the hopper 20, or the like.

In an embodiment, each wheel 60 of the set of wheels is of the open wheel type and includes a hub 61, a rim 62 and a plurality of spokes 63 extending between the hub 61 and the rim 62. Openings are defined between the spokes 63 and allow the flow of particulate material through the wheels 60, as will be described in more details below. In an embodiment, the wheels 60 have a diameter ranging between about 10 centimeters and about 60 centimeters. In order to provide grip when the particulate material spreader 10 is moved over the surface, in an embodiment, the wheels 60 include a tread pattern. In an embodiment, the tread pattern can be part of a tread cover 64 mountable to the rim 62 and made of softer material than the rim 62, in order to increase the grip of the wheels 60 onto the surface.

In the embodiment shown, the hopper 20 has a bottom wall 24, a peripheral wall 21 extending upwardly from the bottom wall 24 and ending with an open upper end 22, thereby defining a particulate material receiving cavity 23. In the embodiment shown, on its inner surface, the peripheral wall 21 includes measuring marks 18 to allow easy measuring of the quantity of particulate material in the particulate material receiving cavity 23. The bottom wall 24 includes a particulate material outlet 28, allowing the particulate material to flow outwardly from the receiving cavity 23 of the hopper 20, by gravity. In the embodiment shown, the bottom wall 24 is tapered towards the particulate material outlet 28, such that the particulate material is naturally driven towards the particulate material outlet 28 by gravity. In the embodiment shown, the outlet 28 includes four apertures 26 (or through holes) and is located in a substantially middle section of the bottom wall 24. However, one skilled in the art will understand that, in alternative embodiments, a different amount of apertures can be provided and the outlet 28 can be positioned differently than at the middle section of the bottom wall 24.

In an embodiment, the hopper 20 also includes frame engaging projections 29 extending downwardly and forwardly from an outer surface 24a of the bottom wall 24 of the hopper 20, the purpose of which will be described in more details below.

In the embodiment shown, the spreader frame 46 is of unitary construction (i.e. is a single piece component) and includes a hopper engaging wall 47, a distribution channel 48, the above-mentioned handle receiving cavity 55 and two wheel engaging supports 51. One skilled in the art will understand that, in an alternative embodiment (not shown), the spreader frame 46 can be embodied by a plurality of parts or pieces connected to one another, rather than by a unitary component. The spreader frame 46 extends at least partially below the hopper 20 and is engageable therewith in order to support the hopper 20 thereon. In an embodiment, the spreader frame 46 is the central component of the particulate material spreader 10 (i.e. the component onto which the other components, such as the hopper 20, the set of wheels 60 and the handle 30, are connected).

In the embodiment shown, the hopper engaging wall 47 is the upper wall of the spreader frame 46 for engaging and supporting the bottom wall 24 of the hopper 20. When the hopper 20 is mounted to the undercarriage 76, the outer surface 24a of the bottom wall 24 of the hopper 20 is juxtaposed to the hopper engaging wall 47 of the spreader frame 46. In the embodiment shown, the hopper engaging wall 47 includes projection receiving cavities 54 sized and shaped to receive therein at least a portion of the frame engaging projections 29 of the hopper 20. In the embodiment shown, such a combination of the complementary projection receiving cavities 54 of the spreader frame 46 and the frame engaging projections 29 of the hopper 20 allows the hopper 20 to be detachably mounted to the spreader frame 46, as will be described in more details below. One skilled in the art will understand that, in alternative embodiments (not shown), other male-female assemblies different from the one of the embodiment shown could also be used for detachably mounting the hopper 20 to the spreader frame 46.

The distribution channel 48 is defined by a through hole extending through the spreader frame 46. When the hopper 20 is mounted to the undercarriage 76, the distribution channel 48 is substantially aligned with the outlet 28 of the hopper 20 and is in particulate material communication therewith. Hence, the distribution channel 48 receives therein the flow of particulate material from the hopper 20, as will be described in more details below.

The handle receiving cavity 55 is located at a rear end of the spreader frame 46 and, as described above, is sized and shaped to receive therein the undercarriage engaging end 32a of the lower section 32 of the handle 30.

The wheel engaging supports 51 are each located on opposite lateral ends of the spreader frame 46 and each include a wheel engaging end 51a for rotatably mounting a respective one of the wheel 60 of the particulate material spreader 10. In an embodiment, the wheel engaging ends 51a include a hub receiving channel 51b for receiving therein a projecting member of the hub 61 of the corresponding wheel 60 for rotatably mounting the wheels 60 to the spreader frame 46. One skilled in the art will however understand that, in alternative embodiments (not shown) other known mounting means or methods can be used for mounting the wheels 60 to the wheel engaging supports 51 of the spreader frame 46. For example and without being limitative, in an embodiment (not shown), the wheel engaging ends 51a could include projecting members each engageable in a corresponding receiving channel 51b of the hub 61 of the corresponding wheel 60.

The spreading assembly 59 is operative to distribute the particulate material around the particulate material spreader 10, when the particulate material spreader 10 is moved over the surface by the user. In the embodiment shown, the spreading assembly 59 also substantially prevents leaking of particulate material from the hopper 20 when the particulate material spreader 10 is stationary.

In the embodiment shown, the spreading assembly 59 includes a wheel axle 70, a bevelled gear assembly 71, a distribution shaft 74, an auger 65 and a distribution plate 66. In an embodiment, the spreading assembly 59 is at least partially circumscribed by the spreader frame 46 (i.e. the spreading assembly 59 is at least partially positioned within a section of the spreader frame 46). The wheel axle 70 is a driving shaft extending along a substantially horizontal axis X defined between the wheels 60 and driven in rotation when the wheels 60 are rotated. The wheel axle 70 is operatively connected to the distribution shaft 74 extending along a substantially vertical axis Y, through the bevelled gear assembly 71. In the embodiment shown, the bevelled gear assembly 71 includes a spur gear 72 and a pinion gear 73 driven by the spur gear 72. The spur gear 72 is mounted to the wheel axle 70 such that the spur gear 72 rotates along with the wheel axle 70. The spur gear 72 drives the pinion gear 73 in rotation, which in turn drives the distribution shaft 74 extending therefrom. Such a bevelled gear assembly is well known in the art for coupling rotation from a substantially horizontal drive shaft (the wheel axle 70 driven by the wheels 60) to a substantially vertical shaft (the distribution shaft 74 driven by the pinion gear 73). One skilled in the art will understand that, in alternative embodiments (not shown), other assemblies or gear combination, could be used instead of the above described bevelled gear assembly 71, for driving the distribution shaft 74 when the wheel axle 70 is rotated.

In the embodiment shown, the distribution plate 66 and the auger 65 are mounted onto the distribution shaft 74. Hence, when the particulate material spreader 10 is moved over the surface, the distribution plate 66 and the auger 65 are therefore rotated along with the distribution shaft 74, which is in turn driven in rotation by the rotating wheel axle 70 rotating along with the rotation of the wheels 60.

To control the flow of particulate material through the distribution channel 48 (i.e. to selectively allow/prevent such flow of particulate material), in the embodiment shown, the auger 65 extends along the distribution channel 48 of the spreader frame 46 and is sized and shaped to substantially cover the internal space of the distribution channel 48. In other words, the auger 65 closely fit into the distribution channel 48. Such positioning and configuration of the auger 65 allows a flow of particulate material through the distribution channel 48, only when the particulate material spreader 10 is moved over the surface. Indeed, in operation, when the spreader 10 is moved across the ground, the wheels 60 turn and rotate the wheel axle 70, which rotates the distribution shaft 74 and therefore also rotates the auger 65. Upon rotation of the auger 65, the helical walls 65a, 65b, 65c of the auger 65 drive the particulate material downwardly through the distribution channel 48, thereby allowing the particulate material to flow therethrough. Conversely, when the particulate material spreader 10 is stationary, the wheels 60 do not turn and result in the auger 65 remaining still (i.e. the auger not rotating) inside the distribution channel 48. When the auger 65 is still, the helical walls 65a, 65b, 65c of the auger 65 substantially prevent the flow of particulate material through the distribution channel 48, thereby preventing spilling thereof. Hence, the use of the auger 65 in the distribution channel 48 located below the hopper 20 automatically limits the flow of particulate material through the distribution channel 48 to time periods where the particulate material spreader 10 is moved over the surface, without requiring additional user operated component. One skilled in the art will understand that, in an alternative embodiment (not shown), the auger 65 can be positioned differently than inside the distribution channel 48 of the spreader frame 46, such as, for example, in a channel defined in the hopper, downstream of the outlet 28 of the particulate material receiving cavity 23.

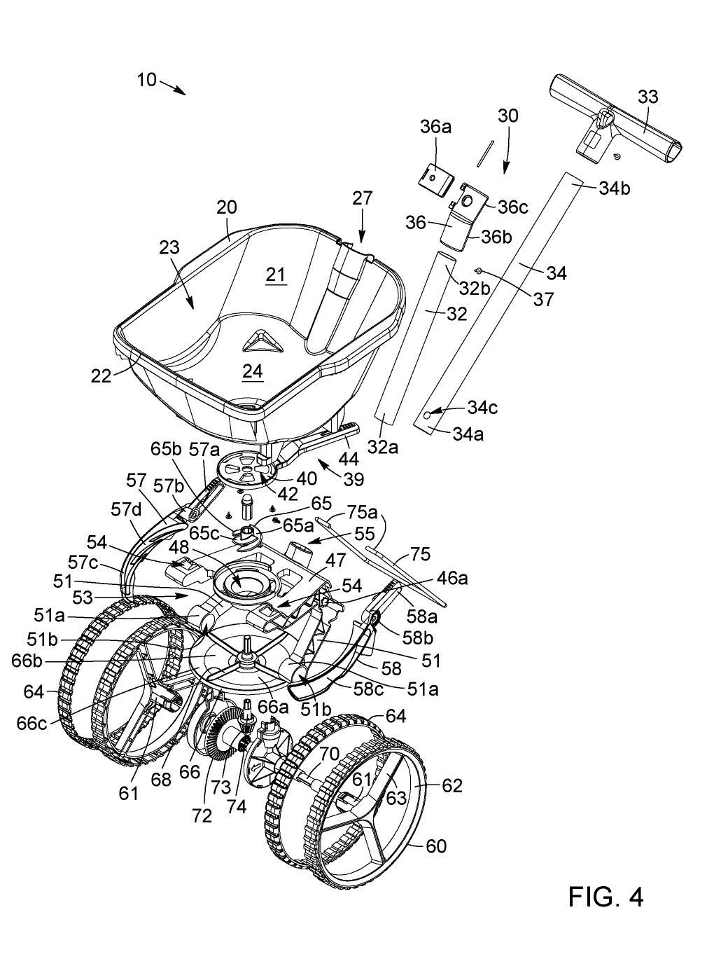

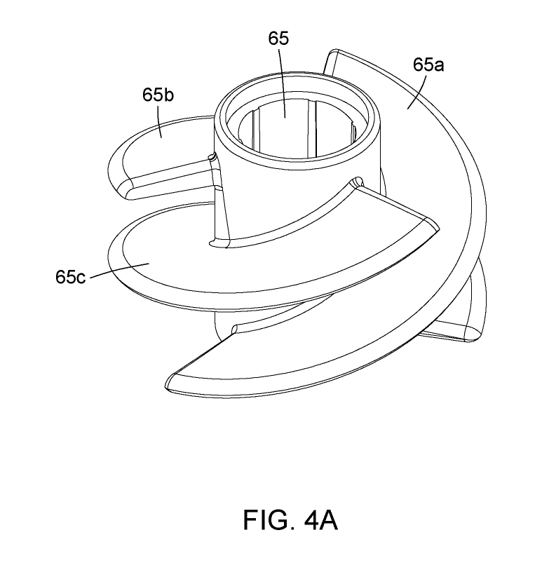

In the embodiment shown, and as can be better seen in FIG. 4a, the auger 65 includes three alternating helical walls 65a, 65b and 65c in order to favor the regulation of the movement of the particulate material through the distribution channel 48. One skilled in the art will however understand that, in alternative embodiments (not shown), the auger 65 can include less or more than three alternating helical walls 65a, 65b and 65c. In an embodiment, the helical walls 65a 65b, 65c of the auger 65 are made of resilient material such as, for example and without being limitative elastomeric material or the like to allow momentary bending thereof. Momentary bending of at least one of the helical walls 65a 65b and 65c allows rotation of the auger 65 to continue unimpeded (rather than causing an auger jam) in the case of a granular particle being wedged between a section of one of the helical walls 65a 65b, 65c of the auger 65 and a peripheral wall of the distribution channel 48, when particulate material is flowing through the distribution channel 48.

In the embodiment shown, each one of the helical walls 65a, 65b and 65c covers about 180 degrees. End sections of each one of the helical walls 65a, 65b, 65c overlap with end sections of the other helical walls 65a, 65b, 65c. One skilled in the art will understand that, in alternative embodiments (not shown), each one of the helical walls 65a, 65b, 65c can cover more or less than 180 degrees.

In an embodiment, at least one of the helical walls 65a, 65b and 65c of the auger 65 has a non-slip upper surface preventing the particular material from sliding onto the corresponding one of the helical walls 65a, 65b and 65c, thereby avoiding the flow of particulate material through the distribution channel 48 when the auger 65 is still. In other words, by preventing the slipping between the particulate material and the at least one of the helical walls 65a, 65b and 65c of the auger 65, the particular material spreader 10 retains the particular material located in the auger 65 in place when the auger 65 is still and precludes particular material spills when movement of the particulate material spreader 10 is halted. To provide the non-slip upper surface, in an embodiment, the at least one helical wall 65a, 65band 65c of the auger 65 is made of non-slip material. In an alternative embodiment, a non-slip coating can be applied to the surface of the at least one of the helical walls 65a, 65b and 65c of the auger 65.

The distribution plate 66 is mounted onto the distribution shaft 74, below the distribution channel 48, and extends along a distribution plane D. The distribution plate 66 receives the particulate material from the distribution channel 48, when the auger 65 is rotated and particulate material is driven through the distribution channel 48. Similarly to the auger 65, in operation, when the spreader 10 is moved across the ground, the wheels 60 turn and rotate the wheel axle 70, which rotates the distribution shaft 74 and therefore also rotates the distribution plate 66. The auger 65 and distribution plate 66 hence rotate simultaneously.

As mentioned above, in operation, the distribution plate 66 rotates along with the distribution shaft 74, which is in turn driven in rotation by the rotating wheel axle 70 rotating along with the rotation of the wheels 60. When rotated, the distribution plate 66 distributes the particulate material received thereon around the spreader 10, along the distribution plane D, by centrifugal force. In the embodiment shown, the distribution plate 66 is of substantially circular shape (or disc shape) and includes a plurality of radial vanes 68 to improve the distribution of the particulate material provided thereon, when the distribution plate 66 is rotated.

In the embodiment shown, the distribution plate 66 has a concave inner surface 66a, while still extending substantially along the distribution plane D. In the embodiment shown, the inner surface 66a of the distribution plate 66 has a substantially flat central section 66b and an upwardly angled peripheral section 66c. In such an embodiment, the distribution plane D can be considered as the plane intersecting the peripheral edge of the peripheral section 66c of the distribution plate 66 (i.e. the plane extending substantially horizontally and horizontally aligned with the topmost portion of the distribution plate 66). In an embodiment, the substantially flat central section 66b extends substantially parallel to the distribution plane D and the upwardly angled peripheral section 66c is slightly angled with regard to the distribution plane D. For example and without being limitative, in an embodiment, the upwardly angled peripheral section 66c is angled with regard to the distribution plane D of between about 1 degree and about 15 degrees. In an alternative embodiment, the upwardly angled peripheral section 66c is angled with regard to the distribution plane D of between about 4 degrees and about 8 degrees. The concave inner surface 66a of the distribution plate 66 helps to prevent undesired spillage of the granular material released onto the distribution plate 66 and to impart a small projecting angle to the radially projected granular material and therefore increase the projecting distance thereof. It will be understood that, even though a projecting angle is imparted, the granular material is considered to be radially projected substantially along the distribution plane D. One skilled in the art will understand that, in an alternative embodiment, the distribution plate 66 could have a configuration different than the embodiment shown. For example and without being limitative, in an embodiment, the distribution plate 66 could extend substantially linearly (i.e. could be substantially flat) and extend substantially entirely along the distribution plane D.

One skilled in the art will understand that, in alternative embodiments (not shown), the distribution plate 66 can have a shape different that the substantially circular shape of the embodiment shown, such as a substantially “X” shape or the like. One skilled in the art will understand that the rotating speed of the distribution plate 66 influences the distance of projection of the particulate material around the spreader 10. Hence, in an embodiment, the gear ratio of the bevelled gear assembly and the size of the wheels 60 size is designed to provide the required rotation speed of the distribution plate 66 to reach the desired projection distance of the particulate material. In an embodiment, the gear ratio of the bevelled gear assembly and the size of the wheels 60 provides a ratio of between about 1:2 and about 1:6 between the rotation of the wheels and the rotation of the distribution plate 66.

In the embodiment shown, the particulate material spreader 10 distributes the particulate material through the wheels 60, i.e. the distribution plane D extends through the wheels 60. In other words, the distribution plane D extends inside the rim 62 of the wheels 60, rather than above the wheels 60 as is common in prior art spreaders. In an embodiment, the distribution plane D extends above the hub 61 of the wheels 60 and below an upper part of the rim 62 thereof. The distribution of the particulate material through the wheels 60 allows the wheels 60 to be of a greater diameter than wheels commonly used for particulate material spreaders (not shown), where distribution of the particulate material needs to be performed over the wheels.

To allow such distribution of the particulate material through the wheels 60, as mentioned above, each one of the wheels 60 is an open wheel (i.e. a wheel having hollow inner sections between the spokes 63 of the wheel 60 and which allow the passage of the particulate material therethrough). Moreover, the spreader frame 46 is also adapted to allow the passage of particulate material distributed by the distribution plate 66 towards the sides thereof. In the embodiment shown, the wheel engaging end 51a of each one of the wheel engaging supports 51 is spaced apart from the hopper engaging wall 47 (i.e. the wheel engaging end 51a of each one of the wheel engaging supports 51 is below and distant from the hopper engaging wall 47), thereby defining a distribution gap 53 for the passage of particulate material distributed by the distribution plate 66 towards the left side and the right side of the particulate material spreader 10.

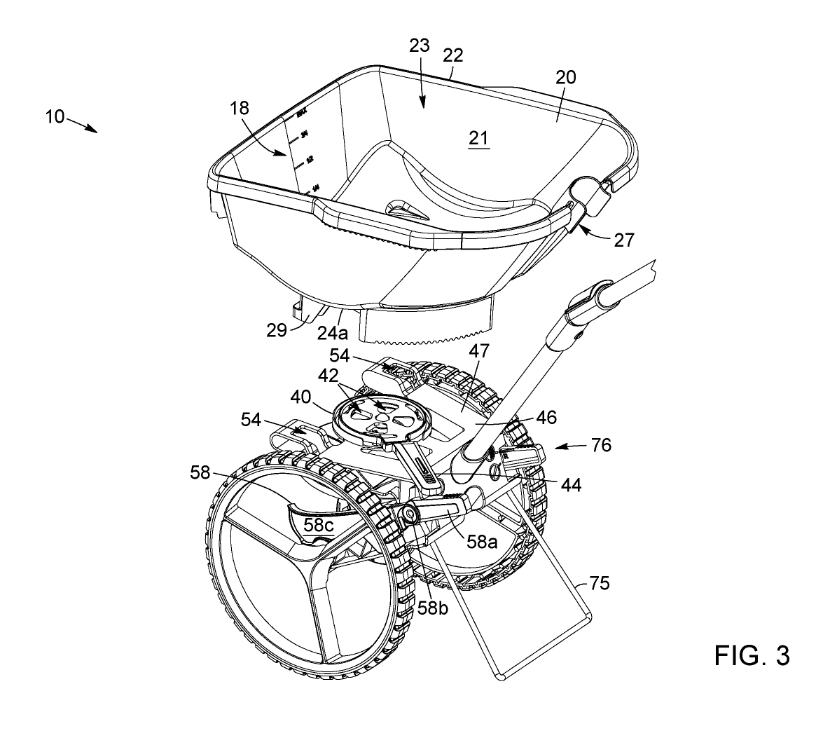

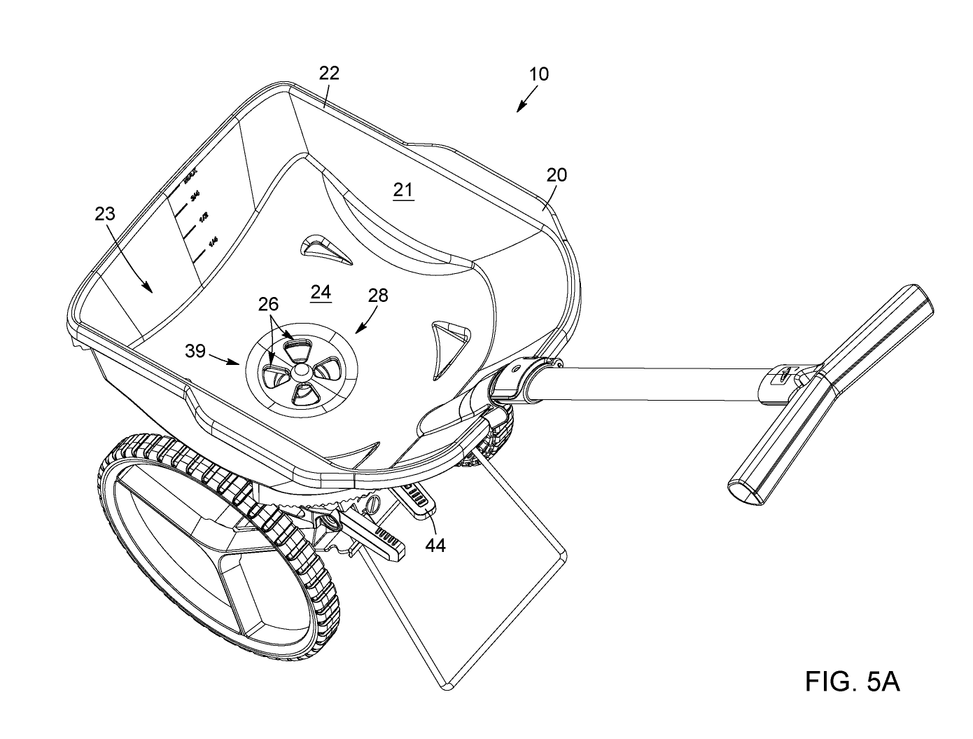

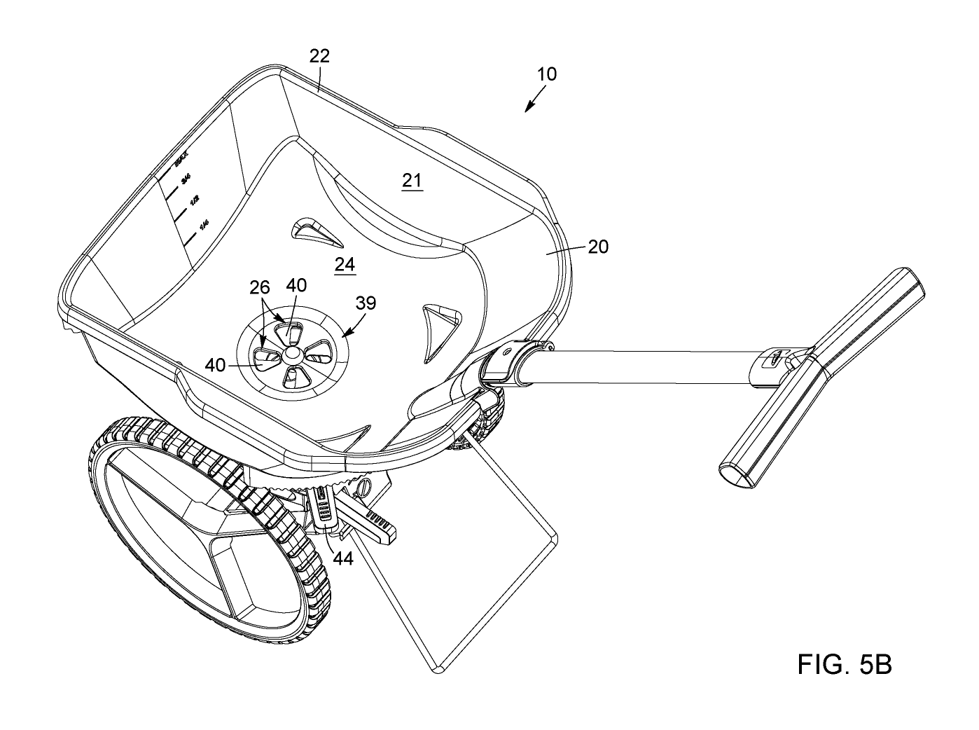

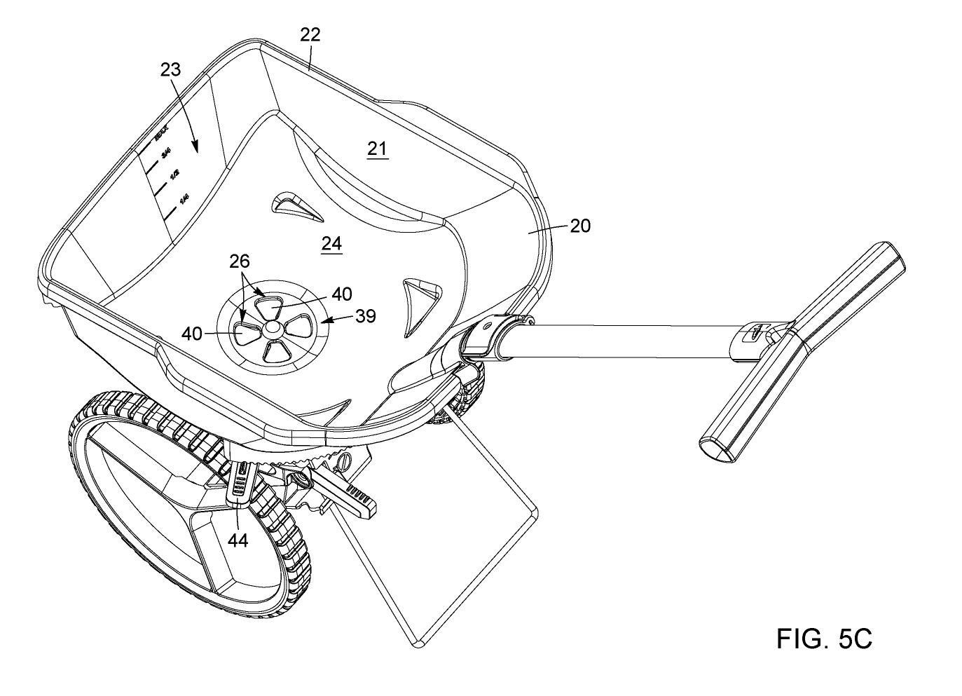

Referring more specifically to FIGS. 3 to 5C, in an embodiment, the spreading assembly 59 also includes a flow regulation assembly 39, configured to regulate the flow of particulate material from the hopper 20. In the embodiment shown, the flow regulation assembly 39 includes a pivotable flow controller 40 with a flow controller handle 44 engageable by a user to manually pivot the flow controller 40 between a fully open configuration (see FIG. 5a), a partially open configuration (see FIG. 5b) and a closed configuration (see FIG. 5c). In an embodiment, the pivotable flow controller 40 is positioned directly below the hopper 20, between the outer surface 24a of the bottom wall 24 of the hopper 20 and the distribution channel 48. The pivotable flow controller 40 has a body with apertures 42 defined therein. In the embodiment shown, the apertures 42 have a beveled edge. The quantity, size and shape of the apertures 42 of the pivotable flow controller 40 is substantially similar to the quantity, size and shape of the apertures 26 defined in the bottom wall 24 of the hopper 20. Hence, in operation, when the greatest flow of particulate material is desired, the flow controller 40 is configured in the fully open configuration (see FIG. 5a), where the apertures 42 defined in the body of the flow controller 40 are substantially in register with the apertures 26 defined in the bottom wall 24 of the hopper 20 (i.e. the apertures 42 defined in the body of the flow controller 40 are substantially aligned with the apertures 26 defined in the bottom wall 24 of the hopper 20). When a lesser flow of particulate material is desired, the flow controller 40 can be configured in the partially open configuration (see FIG. 5b), where the apertures 42 defined in the body of the flow controller 40 are only partially aligned with the apertures 26 defined in the bottom wall 24 of the hopper 20. It will be understood that, in the partially open configuration, the level of alignment of the apertures 42 defined in the body of the flow controller 40 and the apertures 26 defined in the bottom wall 24 of the hopper 20, can be selected by the user according to the desired flow (a greater alignment therebetween resulting in a greater flow). When no flow of particulate material is desired, the flow controller 40 can be configured in the closed configuration (see FIG. 5c), where the apertures 42 defined in the body of the flow controller 40 are offset (i.e. entirely misaligned) from the apertures 26 defined in the bottom wall 24 of the hopper 20 and the flow controller 40 thereby closes the apertures 26 defined in the bottom wall 24 of the hopper 20.

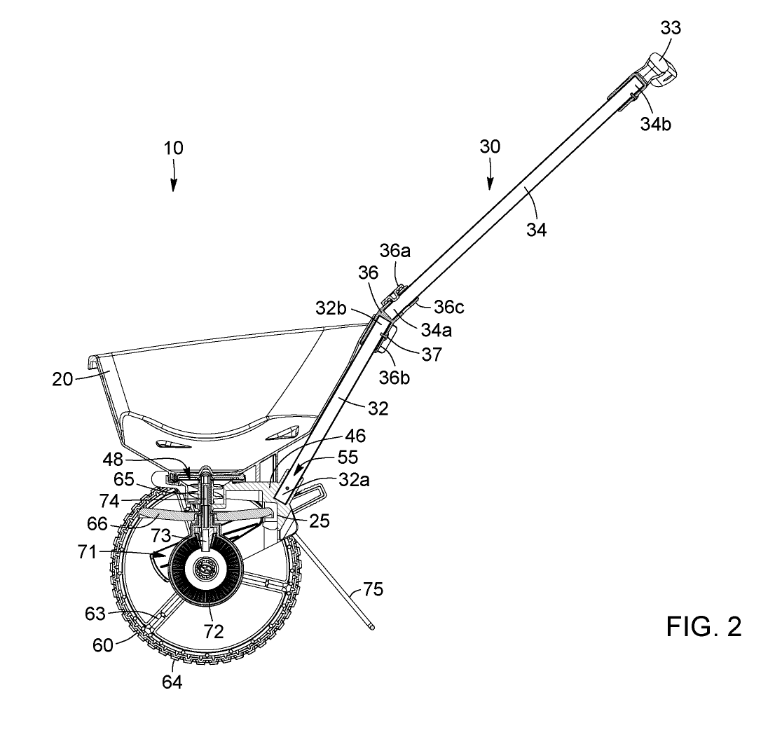

Referring generally to FIG. 2, in an embodiment, the spreader frame 46 also includes a rear blocking wall 25 preventing distribution of particulate material by the distribution plate 66 towards the rear of the particulate material spreader 10. The rear blocking wall 25 of the spreader frame 46 intersects with the distribution plane D. In an embodiment, the rear blocking wall 25 has a curved profile substantially matching the profile of a peripheral edge of the distribution plate 66 and extends proximate to the peripheral edge of the corresponding section of the peripheral edge of the distribution plate 66 (i.e. the section of the distribution plate 66 currently positioned in an angular position to match the position of the rear blocking wall 25, as a result of the rotation of the distribution plate 66). The combination of the disc shape distribution plate 66 and the curved rear blocking wall 25 minimizes the quantity of particulate material falling to the ground towards the rear of the particulate material spreader 10, most of the particulate material simply bouncing off the rear blocking wall 25 and remaining on the distribution plate 66, along the length of the rear blocking wall 25.

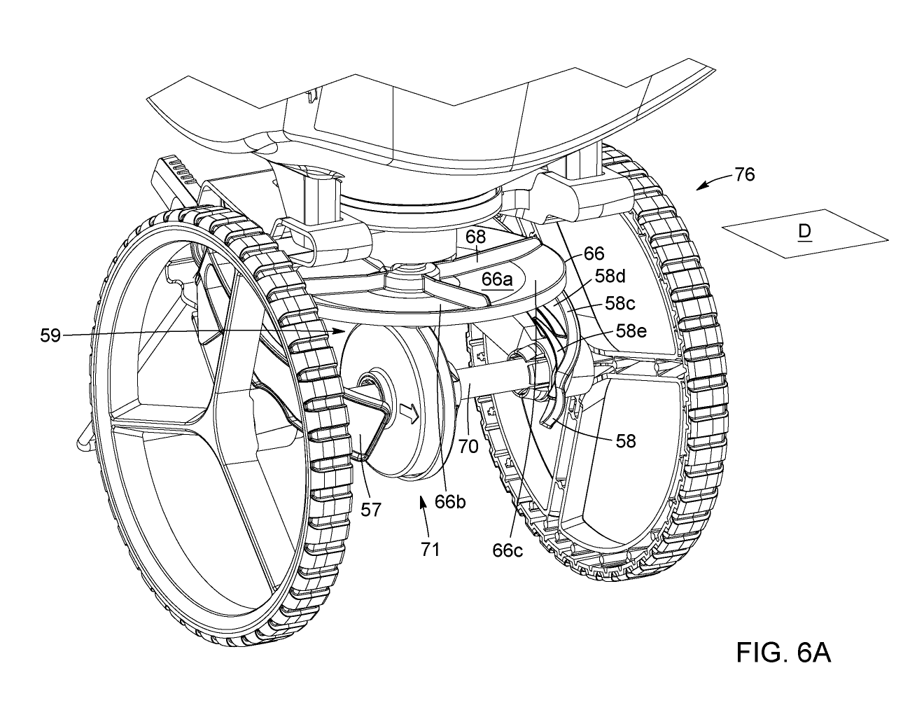

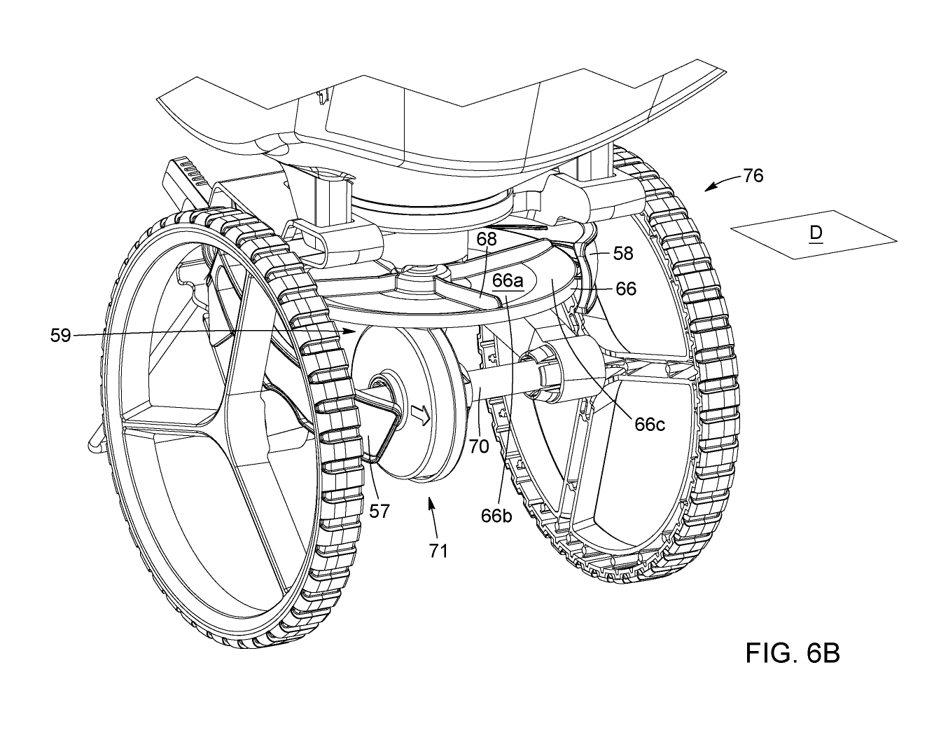

Referring to FIGS. 4, 6A and 6B, in an embodiment, the spreading assembly 59 of the particulate material spreader 10 further includes lateral blocking walls 57, 58 pivotally mounted to the spreader frame 46, on opposite sides thereof. Each one of the lateral blocking walls 57, 58 is vertically pivotable between a dispensing configuration and a blocking configuration (i.e. the lateral blocking walls 57, 58 pivot substantially along the vertical axis Y between the dispensing configuration and the blocking configuration). In the dispensing configuration, the lateral blocking walls 57, 58 do not impact the dispensing of the particulate material by the distribution plate 66. In the blocking configuration, the lateral blocking walls 57, 58 selectively prevent dispensing of particulate material towards the corresponding side of the particulate material spreader 10. Each one of the lateral blocking walls 57, 58 includes a frame engaging section 57b, 58b pivotally mounted to the spreader frame 46, a handle 57a, 58a engageable by a user to pivot the corresponding one of the lateral blocking walls 57, 58 between the dispensing configuration and the blocking configuration and a blocking section 57c, 58c. The blocking section 57c, 58c is the portion of the lateral blocking walls 57, 58 which prevents the distribution of the particulate material on the corresponding side of the particulate material spreader 10 when the lateral blocking wall 57, 58 is configured in the blocking configuration and allows unimpeded distribution of the particulate material on the corresponding side of the particulate material spreader 10 when the lateral blocking wall is configured in the dispensing configuration.

In FIG. 6A, each one of the lateral blocking walls 57, 58 is configured in the dispensing configuration, thereby allowing the spreading of the particulate material by the distribution plate 66. In the embodiment shown, in the dispensing configuration, the blocking section 57c, 58c is supported on the hub 61 of the corresponding wheel 60 and extends below the distribution plane D of the distribution plate 66. One skilled in the art will understand that, in alternative embodiments (not shown), in the dispensing configuration, the lateral blocking walls 57, 58 could however have a different configuration than the embodiment shown while still allowing unimpeded spreading of the particulate material by the distribution plate 66. For example and without being limitative, in the dispensing configuration, the blocking section 57c, 58c can be configured above the distribution plane D. In FIG. 6B, the left side lateral blocking wall 57 is configured in the dispensing configuration and the right side lateral blocking wall 58 is configured in the blocking configuration. In the embodiment shown, when the right side lateral blocking wall 58 is configured in the blocking configuration, the blocking section 58c thereof is substantially levelled with the distribution plate 66 (i.e. the blocking section 58c extends across the distribution plane D) and extends proximate to the peripheral edge thereof, thereby substantially preventing the distribution of the particulate material on the corresponding side of the particulate material spreader 10 (and potential spill between the distribution plate 66 and the corresponding blocking wall 58).

In the embodiment shown, the blocking section 57c, 58c of the lateral blocking walls 57, 58 has a longitudinal curved profile substantially matching the profile of the peripheral edge of the corresponding section of the distribution plate 66 (i.e. the section of the distribution plate 66 currently positioned in an angular position to match the position of the blocking section 57c, 58c of the corresponding lateral blocking wall 57, 58, as a result of the rotation of the distribution plate 66). In the embodiment shown, the blocking section 57c, 58c of the lateral blocking walls 57, 58 also includes at least one elongated projection 57e, 58e extending from an inner surface 57d, 58d of the blocking section 57c, 58c of the lateral blocking walls 57, 58. The at least one elongated projection extends substantially horizontally when the corresponding one of the lateral blocking walls 57, 58 is configured in the blocking configuration. In an embodiment, the at least one elongated projection 57e, 58e extending from the inner surface 57d, 58d of the blocking section 57c, 58c of the lateral blocking walls 57, 58 helps to prevent spillage of the particulate material along the corresponding lateral blocking wall 57, 58, when configured in the blocking configuration (i.e. helps to maintain the particulate material projected towards the lateral blocking walls 57, 58, onto the distribution plate 66).

In an embodiment, the inner surface 57d, 58d of the blocking section 57c, 58c of the lateral blocking walls 57 has a substantially concave configuration along a height thereof. In other words, in such an embodiment, the inner surface 57d, 58d of the lateral blocking wall blocking section 57c, 58c of the lateral blocking walls 57, 58 has a curvilinear profile along a height thereof (i.e. along the vertical axis Y), resulting in the inner surface 57d, 58d of the lateral blocking wall blocking section 57c, 58c being curved inwardly.

As mentioned above, the combination of a disc shape distribution plate 66, longitudinal and/or heightwise curved blocking section 57c, 58c of the lateral blocking walls 57, 58 and/or elongated projections 57e, 58e extending from the inner surface 57d, 58d of the blocking section 57c, 58c, once again minimizes the quantity of particulate material falling to the ground on the corresponding side of the particulate material spreader 10, when the corresponding one of the lateral blocking walls 57, 58 is configured in the blocking configuration.

In view of the above, in operation, when a user wishes to prevent the particulate material spreader 10 to distribute particulate material toward one or both of the sides thereof, the user uses the handle(s) 57a, 58a to pivot the corresponding one of the lateral blocking walls 57, 58 from the dispensing configuration to the blocking configuration. The user subsequently maintains the corresponding one of the lateral blocking walls 57, 58 in the blocking configuration while moving the particulate material spreader 10, during the time period where the user wishes to prevent the particulate material spreader 10 to distribute particulate material toward one or both of the sides thereof. When avoidance of dispensing of the particulate material spreader 10 toward the corresponding side is no longer desirable, the user releases the corresponding handle 57a, 58a to allow the lateral blocking wall(s) 57, 58 to pivot towards the dispensing configuration.

The combination of the rear blocking wall and both lateral blocking walls 57, 58 allows the particulate material spreader 10 to spread particulate material towards a single narrow path in front of the particulate material spreader 10 when both lateral blocking walls 57, 58 are maintained in the blocking configuration. Such spreading of particulate material towards a single narrow path in front of the particulate material spreader 10 can be of particular relevance to spread abrasive particulate material (such as salt, sand or the like) onto a narrow path, such as a sidewalk, during winter.

Now referring more specifically to FIGS. 1, 3 and 7, in an embodiment, the particulate material spreader 10 can be shifted between an operative configuration where the hopper 20 and the handle 30 are secured to the undercarriage 76 (see FIG. 1), a disassembled configuration where the handle 30 and/or the hopper 20 are detached from the undercarriage 76 (See FIG. 3) and a compacted (or storage) configuration where the handle 30 and/or the hopper 20 are detached from the undercarriage 76, and where the handle 30 and/or the undercarriage 76 can be stored inside the hopper 20 (See FIG. 7). To allow such shifting between the operative configuration, the disassembled configuration and the compacted configuration, the hopper 20 is detachably mountable to the undercarriage 76 and the handle 30 is detachably mountable to one of the undercarriage 76 and the hopper 20. Moreover, the size and shape of the hopper 20 and the undercarriage 76 is designed to allow the undercarriage 76 to at least partially fit into the hopper 20, when configured in the compacted configuration, such as to provide a smaller footprint and/or volume for the particulate material spreader 10 when it is being stored, transported or the like.

In the embodiment shown, to reach the operative configuration, the hopper 20 is secured to the undercarriage 76 and the lower section 32 of the handle 30 is secured to the undercarriage 76. The hopper 20 is mounted to the undercarriage 76 by setting the outer surface 24a of the bottom wall 24 onto the hopper engaging wall 47 of the spreader frame 46 and engaging the frame engaging projections 29 extending from the outer surface 24a of the bottom wall 24 of the hopper 20 into the projection receiving cavities 54 of the hopper engaging wall 47 of the spreader frame 46. Engagement of the frame engaging projections 29 with the projection receiving cavities 54 of the spreader frame 46 helps to secure the hopper 20 on the spreader frame 46 and maintain the hopper 20 in place during use of the particulate material spreader 10. For example and without being limitative, the handle 30 can be press fitted into the handle receiving cavity 55 of the spreader frame 46 and into the receiving cavity 27 of the hopper 20. To switch between the operative configuration and the compacted configuration, the hopper 20 can be released from the undercarriage 76 by disengaging the frame engaging projections 29 from the projection receiving cavities 54 of the spreader frame 46 and pulling the hopper 20 upwardly and away from the undercarriage 76 (See FIG. 3). The lower section 32 of the handle 30 can also be released from the press fit engagement with the undercarriage 76 and the hopper 20. One skilled in the art will understand that, in alternative embodiments (not shown), several assemblies or methods different than that of the embodiment shown could be used for detachably mounting the hopper 20 to the undercarriage 76 and the handle 30 to the undercarriage 76 and/or the hopper 20.

One skilled in the art will also understand that, in an embodiment, the hopper 20 can be detached for the undercarriage 76 momentarily, for example to fill the hopper 20 with particulate material. Such momentary detachment of the hopper 20 from the undercarriage 76, allows the hopper 20 to be laid on the ground during filling thereof, thereby minimizing the risks of tipping of the particulate material spreader 10 during such operation. In such embodiments, the hopper 20 can once again be released from the undercarriage 76 by disengaging the frame engaging projections 29 from the projection receiving cavities 54 of the spreader frame 46 and pulling the hopper 20 upwardly and away from the undercarriage 76. The hopper 20 can subsequently be laid on the ground during filling thereof and subsequently be reengaged with the undercarriage 76 (in the dispensing configuration) through the reverse sequence of operation. In an embodiment, momentary detachment of the hopper 20 from the undercarriage 76 can also facilitate cleaning of the hopper 20 and/or the undercarriage 76.

In an embodiment, the main components of the particulate material spreader, such as the, hopper 20, the handle 30 and the undercarriage 76 can be made of non-rusting material, such as plastic, aluminum, or the like in order to avoid rust issues, for example when used with oxidizing material such as fertilizer, lime, salt, or the like. In an embodiment, the hopper 20 and the undercarriage 76 are made of plastic material and the handle 30 is made of aluminum. In an embodiment, the stand 75 is made of metal, since any rust issues of the stand 75 have no substantial impact on the proper functioning of the spreader 10. However, one skilled in the art will understand that, in an embodiment, the stand could also be made of non-rusting material. One skilled in the art will understand that, in alternative embodiments, other material offering sufficient strength and stiffness can be used for the components of the particulate material spreader 10.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A particulate material spreader for radially projecting granular material substantially along a distribution plane when moved over a surface, the particulate material spreader comprising:
a hopper defining a particulate material receiving cavity having a particulate material outlet;
a set of open wheels operatively connected to the hopper and supporting the hopper above the ground; and
a spreading assembly at least partially extending between the hopper and the set of open wheels, the spreading assembly being configured to radially project the particulate material through at least one wheel of the set of open wheels and comprising:
a wheel axle extending between the open wheels and rotating along with the open wheels when the particulate material spreader is moved over the surface;
a distribution shaft operatively connected to the wheel axle to rotate along therewith; and
a distribution plate mounted to the distribution shaft and extending substantially along the distribution plane, the distribution plate receiving the particulate material from the hopper and radially projecting the particulate material substantially along the distribution plane extending through at least one wheel of the set of open wheels.

2. The particulate material spreader of claim 1, wherein the wheels have a hub and a rim, the distribution plane extending above the hub and below an upper section of the rim for projecting the particulate material through at least one wheel of the set of open wheels.

3. The particulate material spreader of claim 1 or 2, further comprising an undercarriage comprising a spreader frame extending at least partially below the hopper and engageable therewith, the undercarriage further comprising the set of open wheels rotatably mounted to the spreader frame and the spreading assembly.

4. The particulate material spreader of claim 3, wherein the spreader frame comprises a hopper engaging wall engageable with the hopper and wheel engaging supports, each one of the wheel engaging supports having a wheel engaging end with a respective one of the wheels mounted thereon and wherein the wheel engaging end of each one of the wheel engaging supports is vertically spaced apart from the hopper engaging wall to define a distribution gap therebetween.

5. The particulate material spreader of claim 3 or 4, wherein the spreader frame comprises a distribution channel in particulate material communication with the outlet of the material receiving cavity of the hopper and wherein the spreading assembly further comprises an auger mounted to the distribution shaft, the auger being positioned inside the distribution channel and controlling the flow of particulate material through the distribution channel.

6. The particulate material spreader of claim 5, wherein the auger comprises multiple helical walls.

7. The particulate material spreader of claim 6, wherein the auger comprises at least three helical walls with overlapping end sections.

8. The particulate material spreader of claim 6 or 7, wherein each one of the helical walls of the auger is made of resilient material.

9. The particulate material spreader of any one of claims 6 to 8, wherein at least one of the helical walls of the auger has a non-slip upper surface.

10. The particulate material spreader of any one of claims 4 to 9, wherein the particulate material spreader is configurable between an operative configuration where the hopper is secured onto the spreader frame of the undercarriage and a disassembled configuration where the hopper is disengaged from the spreader frame of the undercarriage.

11. The particulate material spreader of claim 10, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

12. The particulate material spreader of claim 10 or 11, wherein the particulate material spreader is further configurable in a compacted configuration where the undercarriage is at least partially received in the particulate material receiving cavity of the hopper.

13. The particulate material spreader of any one of claims 10 to 12, wherein the hopper has an outer surface including at least one of a male member and a female member, the hopper engaging wall of the spreader frame comprising at least one of the other one of the male member and the female member for engagement of the hopper to the hopper engaging wall in a male-female relationship.

14. The particulate material spreader of claim 13, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

15. The particulate material spreader of any one of claims 1 to 14, wherein the spreading assembly further comprises at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

16. The particulate material spreader of claim 15, wherein the distribution plate is substantially circular and has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

17. The particulate material spreader of claim 16, wherein the spreading assembly further comprises a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

18. The particulate material spreader of any one of claims 15 to 17, wherein the inner surface of the at least one lateral blocking wall comprises at least one elongated projection extending therefrom, the at least one elongated projection being substantially horizontal when the at least one lateral blocking wall is configured in the blocking configuration.

19. The particulate material spreader of any one of claims 15 to 18, wherein the inner surface of the at least one lateral blocking wall has a substantially concave configuration along a height thereof.

20. The particulate material spreader of any one of claims 1 to 19, wherein the outlet of the particulate material receiving cavity of the hopper comprises at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

21. A particulate material spreader comprising:
a hopper defining a particulate material receiving cavity having a particulate material outlet;
a set of wheels operatively connected to the hopper and supporting the hopper above the ground; and
a spreading assembly at least partially extending between the hopper and the set of wheels, the spreading assembly comprising:
a wheel axle extending between the wheels and rotating along with the wheels;
a distribution shaft operatively connected to the wheel axle and rotating along therewith;
a distribution plate mounted to the distribution shaft rotating along with the distribution shaft, the distribution plate receiving the particulate material from the hopper and radially projecting the particulate material upon rotation thereof; and
an auger mounted to the distribution shaft and rotating along with the distribution shaft, the auger being positioned between the outlet of the particulate material receiving cavity of the hopper and the distribution plate and controlling the flow of particulate material towards the distribution plate.

22. The particulate material spreader of claim 21, further comprising an undercarriage comprising a spreader frame extending at least partially below the hopper and engageable therewith, the undercarriage further comprising the set of wheels rotatably mounted to the spreader frame and the spreading assembly, wherein the spreader frame has a distribution channel in particulate material communication with the outlet of the particulate material receiving cavity of the hopper defined therein and the auger is positioned inside the distribution channel for controlling the flow of particulate material through the distribution channel.

23. The particulate material spreader of claim 22, wherein the spreader frame comprises a hopper engaging wall engageable with the hopper and wheel engaging supports, each one of the wheel engaging supports having a wheel engaging end with a respective one of the wheels mounted thereon and wherein the wheel engaging end of each one of the wheel engaging supports is vertically spaced apart from the hopper engaging wall to define a distribution gap therebetween.

24. The particulate material spreader of any one of claims 21 to 23, wherein the auger comprises multiple helical walls.

25. The particulate material spreader of claim 24, wherein the auger comprises at least three helical walls with overlapping end sections.

26. The particulate material spreader of claim 24 or 25, wherein each one of the helical walls of the auger is made of resilient material.

27. The particulate material spreader of any one of claims 24 to 26, wherein at least one of the helical walls of the auger has a non-slip upper surface.

28. The particulate material spreader of any one of claims 23 to 27, wherein the particulate material spreader is configurable between an operative configuration where the hopper is secured onto the spreader frame of the undercarriage and a disassembled configuration where the hopper is disengaged from the spreader frame of the undercarriage.

29. The particulate material spreader of claim 28, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

30. The particulate material spreader of claim 28 or 29, wherein the particulate material spreader is further configurable in a compacted configuration where the undercarriage is at least partially received in the particulate material receiving cavity of the hopper.

31. The particulate material spreader of any one of claims 28 to 30, wherein the hopper has an outer surface including at least one of a male member and a female member, the hopper engaging wall of the spreader frame comprising at least one of the other one of the male member and the female member for engagement of the hopper to the hopper engaging wall in a male-female relationship.

32. The particulate material spreader of claim 31, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

33. The particulate material spreader of any one of claims 21 to 32, wherein the distribution plate extends substantially along a distribution plane and wherein the spreading assembly further comprises at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

34. The particulate material spreader of claim 33, wherein the distribution plate is substantially circular and has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

35. The particulate material spreader of claim 34, wherein the spreading assembly further comprises a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

36. The particulate material spreader of any one of claims 33 to 35, wherein the inner surface of the at least one lateral blocking wall comprises at least one elongated projection extending therefrom, the at least one elongated projection being substantially horizontal when the at least one lateral blocking wall is configured in the blocking configuration.

37. The particulate material spreader of any one of claims 33 to 36, wherein the inner surface of the at least one lateral blocking wall has a substantially concave configuration along a height thereof.

38. The particulate material spreader of any one of claims 21 to 37, wherein the outlet of the particulate material receiving cavity of the hopper comprises at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

39. The particulate material spreader of any one of claims 21 to 38, wherein the wheels of the set of wheels are open wheels having a hub and a rim and wherein the distribution plate radially projects the particulate material through the open wheels upon rotation thereof.

40. A particulate material spreader comprising:
a hopper defining a particulate material receiving cavity having a particulate material outlet;
a set of wheels operatively connected to the hopper and supporting the hopper above the ground; and
a spreading assembly extending at least partially between the hopper and the set of wheels, the spreading assembly comprising:
a wheel axle extending between the wheels and rotating along with the wheels;
a distribution shaft operatively connected to the wheel axle and rotating along therewith;
a distribution plate mounted to the distribution shaft and rotating along therewith, the distribution plate extending substantially along a distribution plane to receive the particulate material from the hopper and radially project the particulate material substantially along the distribution plane upon rotation thereof; and
at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

41. The particulate material spreader of claim 40, wherein the distribution plate is substantially circular and has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

42. The particulate material spreader of claim 41, wherein the spreading assembly further comprises a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

43. The particulate material spreader of claim 41 or 42, wherein the inner surface of the at least one lateral blocking wall comprises at least one elongated projection extending therefrom, the at least one elongated projection being substantially horizontal when the at least one lateral blocking wall is configured in the blocking configuration.

44. The particulate material spreader of any one of claims 41 to 43, wherein the inner surface of the at least one lateral blocking wall has a substantially concave configuration along a height thereof.

45. The particulate material spreader of any one of claims 41 to 44, further comprising an undercarriage comprising a spreader frame extending at least partially below the hopper and engageable therewith, the undercarriage further comprising the set of wheels rotatably mounted to the spreader frame and the spreading assembly.

46. The particulate material spreader of claim 45, wherein the spreader frame comprises a hopper engaging wall engageable with the hopper and wheel engaging supports, each one of the wheel engaging supports having a wheel engaging end with a respective one of the wheels mounted thereon and wherein the wheel engaging end of each one of the wheel engaging supports is vertically spaced apart from the hopper engaging wall to define a distribution gap therebetween.

47. The particulate material spreader of claim 45 or 46, wherein the spreader frame comprises a distribution channel in particulate material communication with the outlet of the material receiving cavity of the hopper and wherein the spreading assembly further comprises an auger mounted to the distribution shaft, the auger being positioned inside the distribution channel and controlling the flow of particulate material through the distribution channel.

48. The particulate material spreader of claim 47, wherein the auger comprises multiple helical walls.

49. The particulate material spreader of claim 48, wherein the auger comprises at least three helical walls with overlapping end sections.

50. The particulate material spreader of claim 48 or 49, wherein each one of the helical walls of the auger is made of resilient material.

51. The particulate material spreader of any one of claims 48 to 50, wherein at least one of the helical walls of the auger has a non-slip upper surface.

52. The particulate material spreader of any one of claims 46 to 51, wherein the particulate material spreader is configurable between an operative configuration where the hopper is secured onto the spreader frame of the undercarriage and a disassembled configuration where the hopper is disengaged from the spreader frame of the undercarriage.

53. The particulate material spreader of claim 52, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

54. The particulate material spreader of claim 52 or 53, wherein the particulate material spreader is further configurable in a compacted configuration where the undercarriage is at least partially received in the particulate material receiving cavity of the hopper.

55. The particulate material spreader of any one of claims 52 to 54, wherein the hopper has an outer surface including at least one of a male member and a female member, the hopper engaging wall of the spreader frame comprising at least one of the other one of the male member and the female member for engagement of the hopper to the hopper engaging wall in a male-female relationship.

56. The particulate material spreader of claim 55, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

57. The particulate material spreader of any one of claims 40 to 56, wherein the outlet of the particulate material receiving cavity of the hopper comprises at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

58. The particulate material spreader of any one of claims 40 to 57, wherein the wheels of the set of wheels are open wheels having a hub and a rim and wherein the distribution plate radially projects the particulate material through the open wheels upon rotation thereof, the distribution plane extending above the hub and below an upper section of the rim for projecting the particulate material through the open wheels.

59. A particulate material spreader comprising:
a hopper defining a particulate material receiving cavity having a particulate material outlet;
a set of wheels operatively connected to the hopper and supporting the hopper above the ground; and
a spreading assembly at least partially extending between the hopper and the set of wheels, the spreading assembly comprising:
a wheel axle extending between the wheels and rotating along with the wheels;
a distribution shaft operatively connected to the wheel axle and rotating along therewith;
a substantially circular distribution plate having a peripheral edge, the distribution plate being mounted to the distribution shaft to rotate along therewith and extending substantially along a distribution plane, the distribution plate receiving the particulate material from the hopper and radially projecting the particulate material substantially along the distribution plane upon rotation thereof; and
a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

60. The particulate material spreader of claim 59, wherein the spreading assembly further comprises at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards a corresponding side of the particulate material spreader.

61. The particulate material spreader of claim 60, wherein the substantially circular distribution plate has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

62. The particulate material spreader of claim 60 or 61, wherein the inner surface of the at least one lateral blocking wall comprises at least one elongated projection extending therefrom, the at least one elongated projection being substantially horizontal when the at least one lateral blocking wall is configured in the blocking configuration.

63. The particulate material spreader of any one of claims 60 to 62, wherein the inner surface of the at least one lateral blocking wall has a substantially concave configuration along a height thereof.

64. The particulate material spreader of any one of claims 59 to 63, further comprising an undercarriage comprising a spreader frame extending at least partially below the hopper and engageable therewith, the undercarriage further comprising the set of wheels rotatably mounted to the spreader frame and the spreading assembly, wherein the rear blocking wall is defined in the spreader frame of the undercarriage.

65. The particulate material spreader of claim 64, wherein the spreader frame comprises a hopper engaging wall engageable with the hopper and wheel engaging supports, each one of the wheel engaging supports having a wheel engaging end with a respective one of the wheels mounted thereon and wherein the wheel engaging end of each one of the wheel engaging supports is vertically spaced apart from the hopper engaging wall to define a distribution gap therebetween.

66. The particulate material spreader of claim 64 or 65, wherein the spreader frame comprises a distribution channel in particulate material communication with the outlet of the material receiving cavity of the hopper and wherein the spreading assembly further comprises an auger mounted to the distribution shaft, the auger being positioned inside the distribution channel and controlling the flow of particulate material through the distribution channel.

67. The particulate material spreader of claim 66, wherein the auger comprises multiple helical walls.

68. The particulate material spreader of claim 67, wherein the auger comprises at least three helical walls with overlapping end sections.

69. The particulate material spreader of claim 67 or 68, wherein each one of the helical walls of the auger is made of resilient material.

70. The particulate material spreader of any one of claims 67 to 69, wherein at least one of the helical walls 65a, 65b and 65c of the auger 65 has a non-slip upper surface.

71. The particulate material spreader of any one of claims 65 to 70, wherein the particulate material spreader is configurable between an operative configuration where the hopper is secured onto the spreader frame of the undercarriage and a disassembled configuration where the hopper is disengaged from the spreader frame of the undercarriage.

72. The particulate material spreader of claim 71, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

73. The particulate material spreader of claim 71 or 72, wherein the particulate material spreader is further configurable in a compacted configuration where the undercarriage is at least partially received in the particulate material receiving cavity of the hopper.

74. The particulate material spreader of any one of claims 71 to 73, wherein the hopper has an outer surface including at least one of a male member and a female member, the hopper engaging wall of the spreader frame comprising at least one of the other one of the male member and the female member for engagement of the hopper to the hopper engaging wall in a male-female relationship.

75. The particulate material spreader of claim 74, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

76. The particulate material spreader of any one of claims 59 to 75, wherein the outlet of the particulate material receiving cavity of the hopper comprises at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

77. The particulate material spreader of any one of claims 59 to 76, wherein the wheels of the set of wheels are open wheels having a hub and a rim and wherein the distribution plate radially projects the particulate material through the open wheels upon rotation thereof, the distribution plane extending above the hub and below an upper section of the rim for projecting the particulate material through the open wheels.

78. A particulate material spreader comprising:
a hopper defining a particulate material receiving cavity; and
an undercarriage comprising a spreader frame engageable with the hopper, a set of wheels rotatably mounted to the spreader frame and a spreading assembly operatively connected to the set of wheels and rotating therewith for spreading the particulate material flowing from the hopper;
wherein the particulate material spreader is configurable between an operative configuration where the hopper is secured onto the spreader frame of the undercarriage and a disassembled configuration where the hopper is disengaged from the spreader frame.

79. The particulate material spreader of claim 78, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

80. The particulate material spreader of claim 78 or 79, wherein the particulate material spreader is further configurable in a compacted configuration where the undercarriage is at least partially received in the particulate material receiving cavity of the hopper.

81. The particulate material spreader of any one of claims 78 to 80, wherein the hopper has an outer surface including at least one of a male member and a female member and wherein the spreader frame comprises a hopper engaging wall engageable with the hopper, the hopper engaging wall comprising at least one of the other one of the male member and the female member for engagement of the hopper to the hopper engaging wall in a male-female relationship.

82. The particulate material spreader of claim 81, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

83. The particulate material spreader of any one of claims 78 to 82, wherein the hopper has a particulate material outlet, the set of wheels is operatively connected to the hopper and supports the hopper above the ground and the spreading assembly at least partially extends between the hopper and the set of wheels, the spreading assembly comprising:
a wheel axle extending between the wheels and rotating along with the wheels;
a distribution shaft operatively connected to the wheel axle and rotating along therewith; and
a distribution plate mounted to the distribution shaft rotating along therewith, the distribution plate receiving the particulate material from the hopper and radially projecting the particulate material upon rotation thereof.

84. The particulate material spreader of claim 83, wherein the spreading assembly comprises an auger mounted to the distribution shaft and rotating along with the distribution shaft, the auger being positioned between the outlet of the particulate material receiving cavity of the hopper and the distribution plate and controlling the flow of particulate material towards the distribution plate.

85. The particulate material spreader of claim 84, wherein the spreader frame has a distribution channel in particulate material communication with the outlet of the particulate material receiving cavity of the hopper defined therein and the auger is positioned inside the distribution channel for controlling the flow of particulate material through the distribution channel.

86. The particulate material spreader of claim 84 or 85, wherein the auger comprises multiple helical walls.

87. The particulate material spreader of claim 86, wherein the auger comprises at least three helical walls with overlapping end sections.

88. The particulate material spreader of claim 86 or 87, wherein each one of the helical walls of the auger is made of resilient material.

89. The particulate material spreader of any one of claims 86 to 88, wherein at least one of the helical walls of the auger has a non-slip upper surface.

90. The particulate material spreader of any one of claims 83 to 89, wherein the distribution plate extends substantially along a distribution plane and wherein the spreading assembly further comprises at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

91. The particulate material spreader of claim 90, wherein the distribution plate is substantially circular and has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

92. The particulate material spreader of claim 91, wherein the spreading assembly further comprises a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

93. The particulate material spreader of any one of claims 90 to 92, wherein the inner surface of the at least one lateral blocking wall comprises at least one elongated projection extending therefrom, the at least one elongated projection being substantially horizontal when the at least one lateral blocking wall is configured in the blocking configuration.

94. The particulate material spreader of any one of claims 90 to 93, wherein the inner surface of the at least one lateral blocking wall has a substantially concave configuration along a height thereof.

95. The particulate material spreader of any one of claims 83 to 94, wherein the outlet of the particulate material receiving cavity of the hopper comprises at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.

96. The particulate material spreader of any one of claims 83 to 95, wherein the wheels of the set of wheels are open wheels having a hub and a rim and wherein the distribution plate radially projects the particulate material through the open wheels upon rotation thereof.

97. A particulate material spreader comprising:
a hopper defining a particulate material receiving cavity;
an undercarriage comprising a spreader frame extending at least partially below the hopper and engageable therewith, a set of wheels rotatably mounted to the spreader frame and a spreading assembly operatively connected to the set of wheels and rotating therewith, the spreading assembly being operative to receive the particulate material from the hopper and spreading the received particulate material.

98. The particulate material spreader of claim 97, wherein the spreading assembly is at least partially circumscribed by the spreader frame.

99. The particulate material spreader of claim 97 or 98, wherein the wheels of the set of wheels of the undercarriage are open wheels having a hub and a rim and wherein the spreading assembly comprises:
a wheel axle extending between the wheels and rotating along with the wheels;
a distribution shaft operatively connected to the wheel axle and rotating along therewith; and
a distribution plate mounted to the distribution shaft for receiving the particulate material from the hopper and radially projecting the particulate material through the open wheels upon rotation thereof, the distribution plate extending substantially along a distribution plane extending above the hub and below an upper section of the rim for projecting the particulate material through the open wheels.

100. The particulate material spreader of any one of claims 97 to 99, wherein the spreader frame comprises a hopper engaging wall engageable with the hopper and wheel engaging supports, each one of the wheel engaging supports having a wheel engaging end with the wheel mounted thereon and wherein the wheel engaging end of each one of the wheel engaging supports is vertically spaced apart from the hopper engaging wall to define a distribution gap therebetween.

101. The particulate material spreader of any one of claims 97 to 100, wherein the spreader frame comprises a distribution channel defined therein and wherein the spreading assembly further comprises an auger mounted to the distribution shaft, the auger being positioned inside the distribution channel and controlling the flow of particulate material through the distribution channel.

102. The particulate material spreader of claim 101, wherein the auger comprises multiple helical walls.

103. The particulate material spreader of claim 102, wherein the auger comprises at least three helical walls with overlapping end sections.

104. The particulate material spreader of claim 102 or 103, wherein each one of the helical walls of the auger is made of resilient material.

105. The particulate material spreader of any one of claims 102 to 104, wherein at least one of the helical walls of the auger has a non-slip upper surface.

106. The particulate material spreader of any one of claims 97 to 105, wherein the particulate material spreader is configurable between an operative configuration where the hopper is secured onto the spreader frame of the undercarriage and a disassembled configuration where the hopper is disengaged from the spreader frame of the undercarriage.

107. The particulate material spreader of claim 106, further comprising a handle detachably mounted to one of the hopper and the spreader frame of the undercarriage, the handle being secured onto at least one of the hopper and the spreader frame when the particulate material spreader is configured in the operative configuration and being at least partially disengaged from the at least one of the hopper and the undercarriage when the particulate material spreader is configured in the disassembled configuration.

108. The particulate material spreader of claim 106 or 107, wherein the particulate material spreader is further configurable in a compacted configuration where the undercarriage is at least partially received in the particulate material receiving cavity of the hopper.

109. The particulate material spreader of any one of claims 106 to 108, wherein the hopper has an outer surface including at least one of a male member and a female member, the hopper engaging wall of the spreader frame comprising at least one of the other one of the male member and the female member for engagement of the hopper to the hopper engaging wall in a male-female relationship.

110. The particulate material spreader of claim 109, wherein the hopper comprises at least one frame engaging projection projecting from the outer surface of the bottom wall thereof and wherein the hopper engaging wall of the spreader frame comprises at least one projection receiving cavity sized and shaped to receive therein at least a portion of a corresponding one of the at least one frame engaging projection.

111. The particulate material spreader of any one of claims 99 to 110, wherein the spreading assembly further comprises at least one lateral blocking wall for selectively preventing the distribution of particulate material towards a corresponding side of the particulate material spreader, the at least one lateral blocking wall having an inner surface and being vertically pivotable between a dispensing configuration where the lateral blocking wall extends away from the distribution plane and a blocking configuration where the lateral blocking wall extends substantially across the distribution plane, thereby blocking the projection of particulate material towards the corresponding side of the particulate material spreader.

112. The particulate material spreader of claim 111, wherein the distribution plate is substantially circular and has a peripheral edge and wherein the at least one lateral blocking wall has a longitudinal curved profile substantially matching the peripheral edge of the distribution plate, the at least one lateral blocking wall being positioned proximate to a corresponding section of the peripheral edge of the distribution plate when configured in the blocking configuration.

113. The particulate material spreader of claim 112, wherein the spreading assembly further comprises a rear blocking wall extending across the distribution plane along a rear section of the particulate material spreader, the rear blocking wall having a curved profile substantially matching the peripheral edge of the distribution plate and being positioned proximate to a corresponding section of the peripheral edge of the distribution plate to prevent the distribution of particulate material along the rear section of the particulate material spreader.

114. The particulate material spreader of any one of claims 111 to 113, wherein the inner surface of the at least one lateral blocking wall comprises at least one elongated projection extending therefrom, the at least one elongated projection being substantially horizontal when the at least one lateral blocking wall is configured in the blocking configuration.

115. The particulate material spreader of any one of claims 111 to 114, wherein the inner surface of the at least one lateral blocking wall has a substantially concave configuration along a height thereof.

116. The particulate material spreader of any one of claims 97 to 115, wherein the particulate material receiving cavity of the hopper comprises an outlet having at least one aperture and wherein the particulate material spreader comprises a flow controller pivotally mounted below the outlet of the particulate material receiving cavity of the hopper, the flow controller having a flow controller body with at least one aperture defined therein, the quantity, size and shape of the at least one aperture defined in the flow controller body substantially matching the quantity, size and shape of the at least one aperture of the outlet of the particulate material receiving cavity of the hopper and the flow controller being pivotable between a fully open configuration where the at least one aperture defined in the body of the flow controller is substantially in register with the at least one aperture of the outlet of the particulate material receiving cavity of the hopper and a closed configuration where the at least one aperture defined in the body of the flow controller is offset from the at least one aperture of the outlet of the particulate material receiving cavity of the hopper.
